(19) United States
(12) Patent Application Publication
(10) Pub. No.: US 2025/0234433 A1
(43) Pub. Date: Jul. 17, 2025

(54) MULTI-CHANNEL LIGHTING CONTROL SYSTEM AND CONTROL METHOD THEREOF

(71) Applicant: Xiamen PVTECH Co., Ltd., Xiamen (CN)

(72) Inventors: HAO YE, Xiamen (CN); Fuxing Lu, Xiamen (CN); Chengquan Xu, Xiamen (CN)

(73) Assignee: Xiamen PVTECH Co., Ltd., Xiamen (CN)

(21) Appl. No.: 19/015,681

(22) Filed: Jan. 10, 2025

(30) Foreign Application Priority Data
Jan. 15, 2024 (CN) 202410056791.3

(51) Int. Cl. H05B 45/10; H05B 45/325; H05B 47/155; H05B 47/16; H05B 47/165

(52) U.S. Cl. CPC H05B 45/10; H05B 45/325; H05B 47/155; H05B 47/16; H05B 47/165

(57) ABSTRACT

A multi-channel lighting control system includes a control module and a plurality of dimming modules. The control module generates a multi-level control signal and the multi-level control signal includes a plurality of control signal data arranged in a preset sequence. The dimming modules are corresponding to the control signal data respectively and arranged in the preset sequence. Each of the dimming modules, upon receiving the multi-level control signal, performs the signal extraction to extract the first of the control signal data from the multi-level control signal. Then, the dimming modules converts the extracted control signal data by the dimming module into a dimming signal, and outputs the dimming signal to a lighting device corresponding thereto.

### BACKGROUND OF THE INVENTION

### 1. Field of the Invention

The present invention relates to a lighting control system, in particular to a multi-channel lighting control system. The present invention further relates to the multi-channel lighting control method of the system.

### 2. Description of the Prior Art

The Pulse Width Modulation (PWM) dimming technology adjusts the brightness of light-emitting diodes (LEDs) by altering their on and off times. Currently available lighting systems usually employ two PWM control channels: one for brightness control and the other for color temperature control. This control system achieves high efficiency and has therefore been widely adopted in various lighting systems. However, when multi-channel PWM dimming control is required (e.g., 10 channels, 100 channels, etc.), the aforementioned control system cannot effectively manage each channel. Currently available solutions primarily rely on a large number of high-speed field-programmable gate arrays (FPGAs) or high-speed central processing units (CPUs) to achieve multi-channel PWM dimming control, but these solutions significantly increase costs.

### SUMMARY OF THE INVENTION

One embodiment of the present invention provides a multi-channel lighting control system, which includes a control module and a plurality of dimming modules. The control module generates a multi-level control signal, and the multi-level control signal includes a plurality of control signal data arranged in a preset sequence. The dimming modules are corresponding to the control signal data respectively and arranged in the preset sequence. Each of the dimming modules, upon receiving the multi-level control signal, performs a signal extraction to extract the first of the control signal data from the multi-level control signal. Then, the dimming modules converts the extracted control signal data by the dimming module into a dimming signal, and outputs the dimming signal to a lighting device corresponding thereto.

In one embodiment, the control module generates a reset signal after the multi-level control signal is generated and after a preset time period. Each of the dimming modules, upon receiving the reset signal, converts the control signal data extracted by the dimming module into the dimming signal and outputs the dimming signal to the lighting device corresponding thereto.

In one embodiment, each of the dimming modules executes a reset process after receiving the reset signal to wait for the next multi-level control signal.

In one embodiment, each dimming module includes a data latch, and the dimming module stores the control signal data extracted thereby in the data latch.

In one embodiment, each of the dimming modules includes a pulse-width modulation pin, and the dimming module outputs the dimming signal to the lighting device corresponding thereto via the pulse-width modulation pin.

Another embodiment of the present invention provides a multi-channel lighting control method, which includes the following steps: generating a multi-level control signal including a plurality of control signal data arranged in a preset sequence via a control module; receiving the multi-level control signal by a plurality of dimming modules, wherein the dimming modules are corresponding to the control signal data respectively and arranged in the preset sequence; performing a signal extraction by each of the dimming modules upon receiving the multi-level control signal to extract the first of the plurality of control signal data from the multi-level control signal; and converting the control signal data extracted by each of the dimming modules into a dimming signal, and outputting the dimming signal to the lighting devices corresponding thereto by each of the dimming modules.

In one embodiment, the step of converting the control signal data extracted by each of the dimming modules into the dimming signal, and outputting the dimming signal to the e lighting devices corresponding thereto by each of the dimming modules further includes the following steps: generating a reset signal by the control module after the generation of the multi-level control signal is generated and after a preset time period; and receiving the reset signal by each of the dimming modules.

In one embodiment, the multi-channel lighting control method further includes the following step: executing a reset process by each of the dimming modules to wait for the next multi-level control signal.

In one embodiment, each of the dimming modules includes a pulse-width modulation pin, and the dimming module outputs the dimming signal to the lighting device corresponding thereto via the pulse-width modulation pin.

In one embodiment, the step of performing the signal extraction by each of the dimming modules upon receiving the multi-level control signal to extract the first of the plurality of control signal data from the multi-level control signal further includes the following step: storing the control signal data extracted by each of the dimming modules by the data latch of each of the dimming modules.

The multi-channel lighting control system and the method thereof in accordance with the embodiments of the present invention may have the following advantages:

(1) In one embodiment of the present invention, the multi-channel lighting control system includes a control module and a plurality of dimming modules. The control module generates a multi-level control signal, and the multi-level control signal includes a plurality of control signal data arranged in a preset sequence. The dimming modules are corresponding to the control signal data respectively and arranged in the preset sequence. Each of the dimming modules, upon receiving the multi-level control signal, performs a signal extraction to extract the first of the control signal data from the multi-level control signal. Then, the dimming modules converts the extracted control signal data by the dimming module into a dimming signal, and outputs the dimming signal to a lighting device corresponding thereto. Via the special signal extraction mechanism and circuit design based on the preset sequence, the multi-channel lighting control system can achieve multi-channel pulse-width modulation dimming control with 256 levels or more. Therefore, the multi-channel lighting control system can meet actual requirements.

(2) In one embodiment of the present invention, each dimming module stores the extracted control signal data in the data latch thereof. The control module generates the multi-level control signal and, after a preset time, produces a reset signal. Upon receiving the reset signal, each dimming module converts the extracted control signal data into a dimming signal and outputs the dimming signal to the corresponding lighting device. Subsequently, the dimming module executes a reset process to wait for the next multi-level control signal. Via the above data latching mechanism and reset mechanism, the multi-channel lighting control system can achieve multi-channel pulse-width modulation dimming control with 256 levels or more via the control module and dimming modules, without requiring a large number of high-speed FPGAs or high-speed CPUs. Therefore, the cost of the multi-channel lighting control system can be significantly reduced.

(3) In one embodiment of the present invention, the multi-channel lighting control system features the special signal extraction mechanism and circuit design based on the preset sequence, enabling multi-channel pulse-width modulation dimming control with 256 levels or more. As a result, the application scope of the multi-channel lighting control system can be more extensive in order to conform to the requirements of different applications.

(4) In one embodiment of the present invention, the multi-channel lighting control system can be applied to high-efficiency and environmentally friendly LED lighting devices to achieve multi-channel pulse-width modulation dimming control. Thus, the multi-channel lighting control system realizes various intelligent applications, aligning with future development trends.

(5) In one embodiment of the present invention, the multi-channel lighting control system features a simple circuit design, achieving the desired effects while reducing costs. Therefore, the multi-channel lighting control system offers higher practicality so as to meet the requirements of various applications.

Further scope of applicability of the present application will become more apparent from the detailed description given hereinafter. However, it should be understood that the detailed description and specific examples, while indicating exemplary embodiments of the present invention, are given by way of illustration only, since various changes and modifications within the spirit and scope of the present invention will become apparent to those skilled in the art from this detailed description.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a block diagram of a multi-channel lighting control system in accordance with one embodiment of the present invention.

FIG. 2 is a first schematic view of the multi-channel lighting control system in operation in accordance with one embodiment of the present invention.

FIG. 3 is a second schematic view of the multi-channel lighting control system in operation in accordance with one embodiment of the present invention.

FIG. 4 is a flow chart of a multi-channel lighting control method in accordance with another embodiment of the present invention.

FIG. 5 is a flow chart of a multi-channel lighting control method in accordance with still another embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

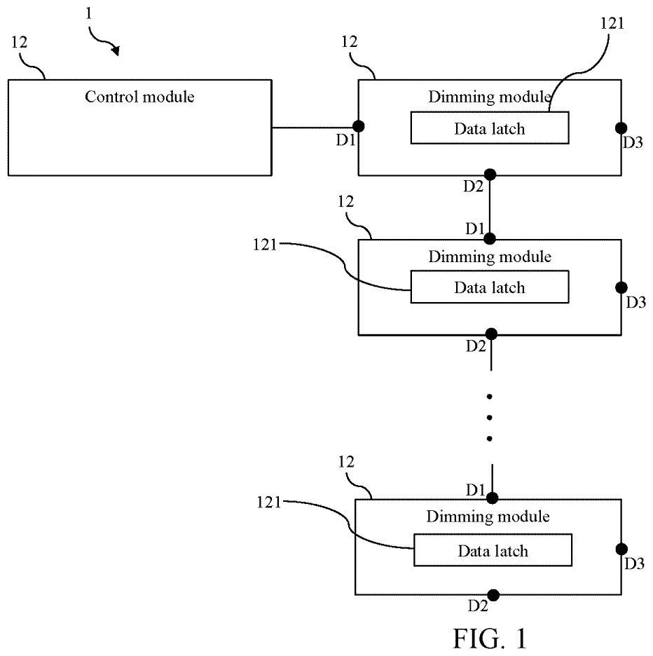

Please refer to FIG. 1, which is a block diagram of a multi-channel lighting control system in accordance with one embodiment of the present invention. As shown in FIG. 1, the multi-channel lighting control system 1 includes a control module 11 and a plurality of dimming modules 12. Each dimming module 12 includes a data latch 121, an input pin D1, an output pin D2, and a dimming pin D3. The control module 11 is connected to one of the dimming modules 12, and the dimming modules 12 are connected to each other. The number of dimming modules 12 can be 256. In another embodiment, the number of dimming modules 12 can also be 100, adjustable based on actual requirements. In this embodiment, the control module 11 can be a central processing unit (CPU). In another embodiment, the control module 11 can be a microcontroller (MCU), application-specific integrated circuit (ASIC), field-programmable gate array (FPGA), or other similar component. In this embodiment, the dimming module 12 can be a microcontroller (MCU). In another embodiment, the dimming module 12 can be a central processing unit (CPU), application-specific integrated circuit (ASIC), field-programmable gate array (FPGA), or other similar components.

The embodiment just exemplifies the present invention and is not intended to limit the scope of the present invention; any equivalent modification and variation according to the spirit of the present invention is to be also included within the scope of the following claims and their equivalents.

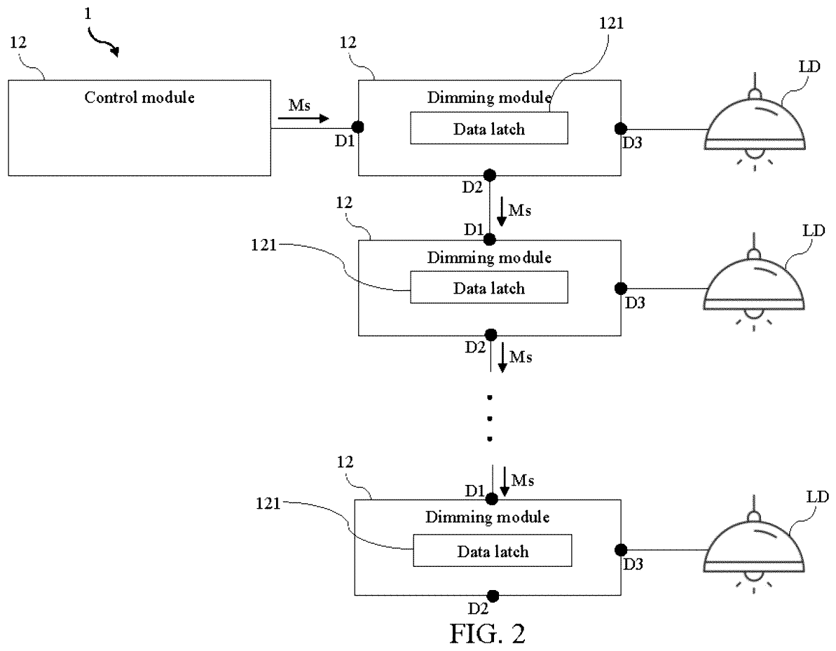

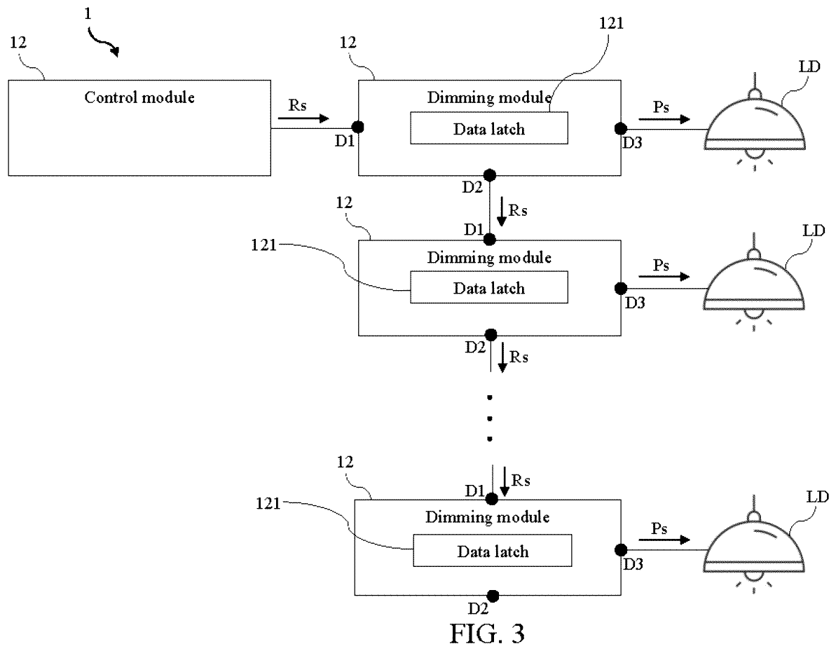

Please refer to FIG. 2 and FIG. 3. FIG. 2 is a first schematic view of the multi-channel lighting control system in operation in accordance with one embodiment of the present invention. FIG. 3 is a second schematic view of the multi-channel lighting control system in operation in accordance with one embodiment of the present invention. As shown in FIG. 2, the dimming modules 12 are connected to a plurality of lighting devices LD, and each dimming module 12 is corresponding to one lighting device LD. The lighting devices LD can be light-emitting diode (LED) lighting devices. In another embodiment, the lighting devices LD can also be fluorescent lamps, bulbs, etc.

The control module 11 generates a multi-level control signal Ms. The multi-level control signal Ms includes a plurality of control signal data arranged in a preset sequence. In this embodiment, the multi-level control signal Ms is 2048 bits, and each control signal data is 8 bits. In another embodiment, the multi-level control signal Ms is 1600 bits, and each control signal data is 16 bits. These examples are merely illustrative, and the multi-level control signal Ms and control signal data can vary depending on actual requirements.

The dimming modules 12 are corresponding to the control signal data respectively and are arranged in the preset sequence. Upon receiving the multi-level control signal Ms, each dimming module 12 performs a signal extraction to extract the first control signal data from the multi-level control signal Ms. In this embodiment, the number of the dimming modules 12 can be 256, corresponding to 256 dimming channels respectively. The multi-level control signal Ms is 2048 bits and includes 256 control signal data, each being 8 bits. That is, the first dimming module 12 receives the multi-level control signal Ms (2048 bits) through the input pin D1 thereof, extracts the first control signal data (8 bits), and transmits the remaining multi-level control signal Ms (2040 bits) to the second dimming module 12 via the output pin D2 thereof. The second dimming module 12 receives the multi-level control signal Ms (2040 bits) via the input pin D1 thereof, extracts the first control signal data (8 bits), and transmits the remaining multi-level control signal Ms (2032 bits) to the third dimming module 12 via the output pin D2 thereof. The extracted control signal data is corresponding to the second control signal data (8 bits) of the initial multi-level control signal Ms. The third dimming module 12 similarly processes the multi-level control signal Ms and transmits it to the fourth dimming module 12. The Nth dimming module 12 receives the multi-level control signal Ms, extracts the first control signal data (8 bits), and transmits the remaining multi-level control signal Ms to the N+1th dimming module 12. The last dimming module (256th dimming module 12) extracts the final control signal data (8 bits) of the initial multi-level control signal Ms. Each dimming module 12 stores tis extracted control signal data in its data latch 121.

As shown in FIG. 3, the control module 11 generates the multi-level control signal Ms and, after a preset time, produces a reset signal Rs. Each dimming module 12, upon receiving the reset signal Rs, converts the extracted control signal data into a dimming signal Ps and outputs the dimming signal Ps to the corresponding lighting device LD via the dimming pin D3 thereof for dimming control. Subsequently, the dimming module 12 passes the reset signal Rs to the next dimming module 12. Finally, upon receiving the reset signal, each dimming module 12 performs a reset process to await the next multi-level control signal Ms.

In summary, in this embodiment, the multi-channel lighting control system 1 includes the control module 11 and the dimming modules 12. The control module 11 generates a multi-level control signal Ms, which includes the control signal data arranged in the preset sequence. The dimming modules 12 are corresponding to the control signal data respectively and are arranged in the preset sequence. Each dimming module 12 extracts the first control signal data from the multi-level control signal Ms, converts the extracted data into the dimming signal Ps, and outputs the dimming signal Ps to the corresponding lighting device LD. Via the special signal extraction mechanism and circuit design based on the preset sequence, the multi-channel lighting control system 1 achieves multi-channel pulse-width modulation dimming control with 256 levels or more, which can meet actual requirements.

Furthermore, in this embodiment, each dimming module 12 stores the extracted control signal data in the data latch 121 thereof. The control module 11 generates the multi-level control signal Ms and, after a preset time, produces a reset signal Rs. Upon receiving the reset signal, each dimming module 12 converts the extracted control signal data into a dimming signal Ps and outputs the dimming signal Ps to the corresponding lighting device LD. Subsequently, the dimming module 12 executes the reset process to await the next multi-level control signal Ms. Via the data latching and reset mechanisms, the multi-channel lighting control system 1 achieves multi-channel pulse-width modulation dimming control with 256 levels or more using the control module 11 and the dimming modules 12, without requiring a large number of high-speed FPGAs or CPUs. Therefore, the cost of the multi-channel lighting control system 1 can be significantly reduced, so the multi-channel lighting control system 1 can be more comprehensive in use and meet the requirements of different applications.

The embodiment just exemplifies the present invention and is not intended to limit the scope of the present invention; any equivalent modification and variation according to the spirit of the present invention is to be also included within the scope of the following claims and their equivalents.

It is worthy to point out that currently available systems primarily rely on a large number of high-speed field-programmable gate arrays (FPGAs) or high-speed central processing units (CPUs) to achieve multi-channel PWM dimming control, which significantly increase the costs of these systems. By contrast, according to the embodiment of the present invention, the multi-channel lighting control system includes a control module and a plurality of dimming modules. The control module generates a multi-level control signal, and the multi-level control signal includes a plurality of control signal data arranged in a preset sequence. The dimming modules are corresponding to the control signal data respectively and arranged in the preset sequence. Each of the dimming modules, upon receiving the multi-level control signal, performs a signal extraction to extract the first of the control signal data from the multi-level control signal. Then, the dimming modules converts the extracted control signal data by the dimming module into a dimming signal, and outputs the dimming signal to a lighting device corresponding thereto. Via the special signal extraction mechanism and circuit design based on the preset sequence, the multi-channel lighting control system can achieve multi-channel pulse-width modulation dimming control with 256 levels or more. Therefore, the multi-channel lighting control system can meet actual requirements.

Also, according to the embodiment of the present invention, each dimming module stores the extracted control signal data in the data latch thereof. The control module generates the multi-level control signal and, after a preset time, produces a reset signal. Upon receiving the reset signal, each dimming module converts the extracted control signal data into a dimming signal and outputs the dimming signal to the corresponding lighting device. Subsequently, the dimming module executes a reset process to wait for the next multi-level control signal. Via the above data latching mechanism and reset mechanism, the multi-channel lighting control system can achieve multi-channel pulse-width modulation dimming control with 256 levels or more via the control module and dimming modules, without requiring a large number of high-speed FPGAs or high-speed CPUS. Therefore, the cost of the multi-channel lighting control system can be significantly reduced.

Further, according to the embodiment of the present invention, the multi-channel lighting control system features the special signal extraction mechanism and circuit design based on the preset sequence, enabling multi-channel pulse-width modulation dimming control with 256 levels or more. As a result, the application scope of the multi-channel lighting control system can be more extensive in order to conform to the requirements of different applications.

Moreover, according to the embodiment of the present invention, the multi-channel lighting control system can be applied to high-efficiency and environmentally friendly LED lighting devices to achieve multi-channel pulse-width modulation dimming control. Thus, the multi-channel lighting control system realizes various intelligent applications, aligning with future development trends.

Furthermore, according to the embodiment of the present invention, the multi-channel lighting control system features a simple circuit design, achieving the desired effects while reducing costs. Therefore, the multi-channel lighting control system offers higher practicality so as to meet the requirements of various applications. As described above, the multi-channel lighting control system and the control method thereof can achieve great technical effects.

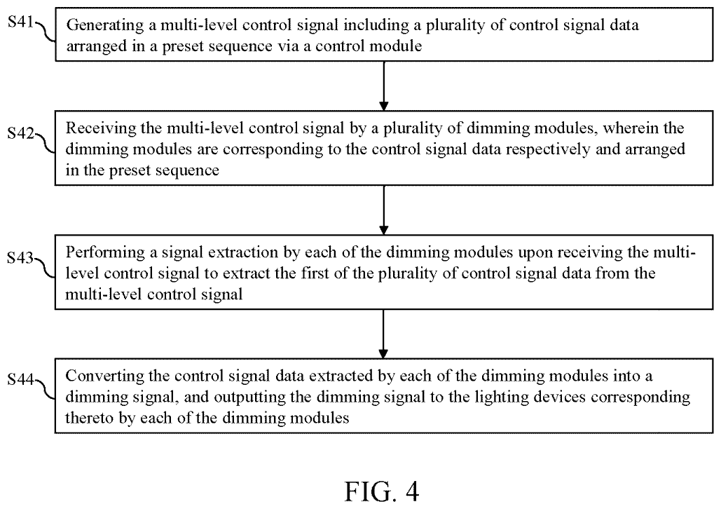

Please refer to FIG. 4, which is a flow chart of a multi-channel lighting control method in accordance with another embodiment of the present invention. As shown in FIG. 4, the multi-channel lighting control method of this embodiment includes the following steps:
Step S41: generating a multi-level control signal including a plurality of control signal data arranged in a preset sequence via a control module.
Step S42: receiving the multi-level control signal by a plurality of dimming modules, wherein the dimming modules are corresponding to the control signal data respectively and arranged in the preset sequence.
Step S43: performing a signal extraction by each of the dimming modules upon receiving the multi-level control signal to extract the first of the plurality of control signal data from the multi-level control signal.
Step S44: converting the control signal data extracted by each of the dimming modules into a dimming signal, and outputting the dimming signal to the lighting devices corresponding thereto by each of the dimming modules.

The embodiment just exemplifies the present invention and is not intended to limit the scope of the present invention; any equivalent modification and variation according to the spirit of the present invention is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

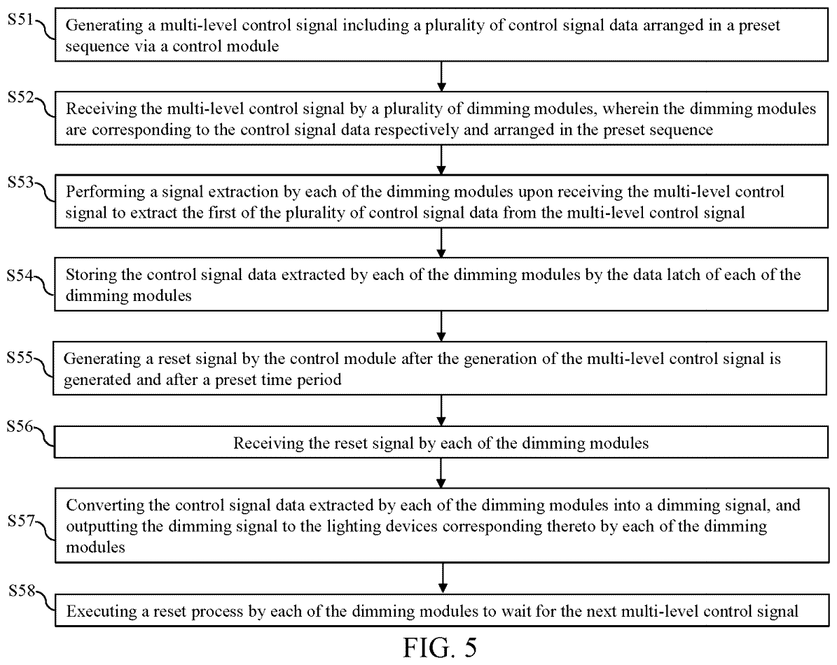

Please refer to FIG. 5, which is a flow chart of a multi-channel lighting control method in accordance with still another embodiment of the present invention. As shown in FIG. 5, the multi-channel lighting control method of this embodiment includes the following steps:
Step S51: generating a multi-level control signal including a plurality of control signal data arranged in a preset sequence via a control module.
Step S52: receiving the multi-level control signal by a plurality of dimming modules, wherein the dimming modules are corresponding to the control signal data respectively and arranged in the preset sequence.
Step S53: performing a signal extraction by each of the dimming modules upon receiving the multi-level control signal to extract the first of the plurality of control signal data from the multi-level control signal.
Step S54: storing the control signal data extracted by each of the dimming modules by the data latch of each of the dimming modules.
Step S55: generating a reset signal by the control module after the generation of the multi-level control signal is generated and after a preset time period.
Step S56: receiving the reset signal by each of the dimming modules.
Step S57: converting the control signal data extracted by each of the dimming modules into a dimming signal, and outputting the dimming signal to the lighting devices corresponding thereto by each of the dimming modules.
Step S58: executing a reset process by each of the dimming modules to wait for the next multi-level control signal.

The embodiment just exemplifies the present invention and is not intended to limit the scope of the present invention; any equivalent modification and variation according to the spirit of the present invention is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

To sum up, according to the embodiment of the present invention, the multi-channel lighting control system includes a control module and a plurality of dimming modules. The control module generates a multi-level control signal and the multi-level control signal includes a plurality of control signal data arranged in a preset sequence. The dimming modules are corresponding to the control signal data respectively and arranged in the preset sequence. Each of the dimming modules, upon receiving the multi-level control signal, performs a signal extraction to extract the first of the control signal data from the multi-level control signal. Then, the dimming modules converts the extracted control signal data by the dimming module into a dimming signal, and outputs the dimming signal to a lighting device corresponding thereto. Via the special signal extraction mechanism and circuit design based on the preset sequence, the multi-channel lighting control system can achieve multi-channel pulse-width modulation dimming control with 256 levels or more. Therefore, the multi-channel lighting control system can meet actual requirements.

Also, according to the embodiment of the present invention, each dimming module stores the extracted control signal data in the data latch thereof. The control module generates the multi-level control signal and, after a preset time, produces a reset signal. Upon receiving the reset signal, each dimming module converts the extracted control signal data into a dimming signal and outputs the dimming signal to the corresponding lighting device. Subsequently, the dimming module executes a reset process to wait for the next multi-level control signal. Via the above data latching mechanism and reset mechanism, the multi-channel lighting control system can achieve multi-channel pulse-width modulation dimming control with 256 levels or more via the control module and dimming modules, without requiring a large number of high-speed FPGAs or high-speed CPUs. Therefore, the cost of the multi-channel lighting control system can be significantly reduced.

Further, according to the embodiment of the present invention, the multi-channel lighting control system features the special signal extraction mechanism and circuit design based on the preset sequence, enabling multi-channel pulse-width modulation dimming control with 256 levels or more. As a result, the application scope of the multi-channel lighting control system can be more extensive in order to conform to the requirements of different applications.

Moreover, according to the embodiment of the present invention, the multi-channel lighting control system can be applied to high-efficiency and environmentally friendly LED lighting devices to achieve multi-channel pulse-width modulation dimming control. Thus, the multi-channel lighting control system realizes various intelligent applications, aligning with future development trends.

Furthermore, according to the embodiment of the present invention, the multi-channel lighting control system features a simple circuit design, achieving the desired effects while reducing costs. Therefore, the multi-channel lighting control system offers higher practicality so as to meet the requirements of various applications.

It will be apparent to those skilled in the art that various modifications and variations can be made to the disclosed embodiments. It is intended that the specification and examples be considered as exemplary only, with a true scope of the present invention being indicated by the following claims and their equivalents.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multi-channel lighting control system, comprising:
a control module configured to generate a multi-level control signal comprising a plurality of control signal data arranged in a preset sequence; and
a plurality of dimming modules corresponding to the control signal data respectively and arranged in the preset sequence, wherein each of the dimming modules, upon receiving the multi-level control signal, is configured to perform a signal extraction to extract a first of the control signal data from the multi-level control signal, convert the control signal data extracted by the dimming module into a dimming signal, and output the dimming signal to a lighting device corresponding thereto.

2. The multi-channel lighting control system as claimed in claim 1, wherein the control module is configured to generate a reset signal after the multi-level control signal is generated and after a preset time period, wherein each of the dimming modules, upon receiving the reset signal, is configured to convert the control signal data extracted by the dimming module into the dimming signal and output the dimming signal to the lighting device corresponding thereto.

3. The multi-channel lighting control system as claimed in claim 2, wherein each of the dimming modules is configured to execute a reset process after receiving the reset signal to wait for a next multi-level control signal.

4. The multi-channel lighting control system as claimed in claim 1, wherein each dimming module comprises a data latch, and the dimming module is configured to store the control signal data extracted thereby in the data latch.

5. The multi-channel lighting control system as claimed in claim 1, wherein each of the dimming modules comprises a pulse-width modulation pin, and the dimming module is configured to output the dimming signal to the lighting device corresponding thereto via the pulse-width modulation pin.

6. A multi-channel lighting control method, comprising:
generating a multi-level control signal comprising a plurality of control signal data arranged in a preset sequence via a control module;
receiving the multi-level control signal by a plurality of dimming modules, wherein the dimming modules are corresponding to the control signal data respectively and arranged in the preset sequence;
performing a signal extraction by each of the dimming modules upon receiving the multi-level control signal to extract a first of the plurality of control signal data from the multi-level control signal; and
converting the control signal data extracted by each of the dimming modules into a dimming signal, and outputting the dimming signal to the lighting devices corresponding thereto by each of the dimming modules.

7. The multi-channel lighting control method as claimed in claim 6, wherein a step of converting the control signal data extracted by each of the dimming modules into the dimming signal, and outputting the dimming signal to the lighting devices corresponding thereto by each of the dimming modules further comprises:
generating a reset signal by the control module after the generation of the multi-level control signal is generated and after a preset time period; and
receiving the reset signal by each of the dimming modules.

8. The multi-channel lighting control method as claimed in claim 7, further comprising:
executing a reset process by each of the dimming modules to wait for a next multi-level control signal.

9. The multi-channel lighting control method as claimed in claim 6, wherein each of the dimming modules comprises a pulse-width modulation pin, and the dimming module is configured to output the dimming signal to the lighting device corresponding thereto via the pulse-width modulation pin.

10. The multi-channel lighting control method according to claim 6, wherein a step of performing the signal extraction by each of the dimming modules upon receiving the multi-level control signal to extract the first of the plurality of control signal data from the multi-level control signal further comprises:
storing the control signal data extracted by each of the dimming modules by a data latch of each of the dimming modules.
